(19) United States
(12) Patent Application Publication
(10) Pub. No.: US 2024/0241747 A1
(43) Pub. Date: Jul. 18, 2024

(54) ELECTRONIC CONTROLLER AND ABNORMALITY DETERMINATION METHOD

(71) Applicant: Hitachi Astemo, Ltd., Hitachinaka-shi, Ibaraki (JP)

(72) Inventors: Masashi MIZOGUCHI, Tokyo (JP); Tomohito EBINA, Ibaraki (JP); Kazuyoshi SERIZAWA, Ibaraki (JP); Kenichi OSADA, Ibaraki (JP); Tasuku ISHIGOOKA, Tokyo (JP); Takeshi FUKUDA, Tokyo (JP)

(73) Assignee: Hitachi Astemo, Ltd., Hitachinaka-shi, Ibaraki (JP)

(21) Appl. No.: 18/559,513

(22) PCT Filed: Feb. 4, 2022
(86) PCT No.: PCT/JP2022/004527

§ 371 Date: Nov. 7, 2023

(30) Foreign Application Priority Data
May 12, 2021 (JP) 2021-080743

(51) Int. Cl. G06F 9/455

(52) U.S. Cl. CPC G06F 9/45558; G06F 2009/45579; G06F 2009/45591

(57) ABSTRACT

An electronic controller includes: a virtual machine that accesses a first virtual driver to execute a process; a hypervisor that calls a first real driver of a first peripheral, based on a peripheral access request received from the first virtual driver; an access recording unit that calls the first virtual driver to record a peripheral access request transmitted to the hypervisor; a state recording unit that calls the first real driver to record a state of a register of the first peripheral; and a monitoring unit that monitors an operation of the hypervisor. The monitoring unit determines an abnormality of the hypervisor, based on a record by the access recording unit and on a record by the state recording unit.

### INCORPORATION BY REFERENCE

This application claims priority to Japanese Patent Application No. 2021-80743 filed on May 12, 2021, the contents of which are incorporated herein by reference.

### TECHNICAL FIELD

The present invention relates to an electronic controller.

### BACKGROUND ART

Using a hypervisor allows incorporating a plurality of control software applications running on different operating systems (OSs) into a single microcomputer. As techniques of monitoring a hypervisor, techniques described in JP 2019-144785 A (Patent Literature 1) and JP 2014-106587 A (Patent Literature 2) are known. Patent Literature 1 describes a monitoring program according to which a monitoring virtual machine is run on virtualization software, the monitoring virtual machine being used to monitor a plurality of monitoring targets including the virtualization software, results of given tests executed by the monitoring virtual machine at a given intervals are obtained, the presence or absence of an abnormality in the monitoring virtual machine is determined from the acquired test results, and when the monitoring virtual machine is in an abnormal state, a given state of the plurality of monitoring targets is acquired and a result of determination on the presence or absence of an abnormality in the monitoring virtual machine and the given state of the plurality of monitoring targets are outputted.

Patent Literature 2 describes a method of controlling an I/O device, the method causing a hypervisor and a first gust OS to share an I/O device, according to which the I/O device has a physical function and a virtual function, the hypervisor has a physical driver that uses the physical function, the first guest OS has a virtual driver that uses the virtual function, the hypervisor acquires a state of the I/O device via the physical driver, and when the first guest OS, which monitors the hypervisor, finds the hypervisor being in a given state, a sub-physical driver that operates the I/O device is started and the first guest OS performs data transmission/reception through a data queue preset on a memory.

### SUMMARY OF INVENTION

### Technical Problem

In an electronic controller in which a plurality of control software applications running on different OSs are integrated on one microcomputer (hardware), virtualization software called a hypervisor is used. The hypervisor provides a virtual machine as an environment for operating an OS and a control software application. The virtual machine is a unit with an access authority set therefore for accessing a central processing unit (CPU) on the microcomputer, a memory area, and peripherals mounted on the microcomputer, such as a controller area network (CAN) controller and an analog/digital (A/D) converter. From the perspective of a guest OS and a control software application in each virtual machine, this tells a logically equivalent fact that a CPU, a memory area, and peripherals with no authority for accessing them set are present on a different microcomputer. Generally, to ensure the safety and reliability of an electronic controller, the operation of the electronic controller needs to be monitored to confirm that hardware and software making up the electronic controller are operating normally without developing any abnormality. Particularly, for the case an electronic controller using a hypervisor, monitoring the operation of the hypervisor is necessary.

According to Patent Literature 1, the monitoring virtual machine is installed as a virtual machine, the monitoring virtual machine periodically executes a test pattern and acquires an internal state (normal/abnormal) of the hypervisor, and based on a result of execution of the test pattern and on a result of acquisition of the internal state of the hypervisor, whether an abnormality has occurred in the electronic controller is determined and when the an abnormality has occurred, a range of the influence of the abnormality can be specified. However, because monitoring of the hypervisor in Patent Literature 1 is carried out by acquiring a normal or abnormal state determined by the hypervisor itself, a case where an abnormal state of the hypervisor caused by an abnormality having occurred therein is not properly determined is not taken into consideration, and therefore a normal operation of the hypervisor is not guaranteed. In addition, because acquiring the internal state of the hypervisor is necessary, the technique of Patent Literature 1 cannot be applied to a third party's hypervisor of which an internal state is not opened to the public.

Patent Literature 2 describes a method according to which a counter (watchdog timer) is provided for the hypervisor, the counter is set to meet a requirement that it count up or count down in a given cycle, and when the counter does not update its count within the given period, it is determined that an abnormality has occurred in the hypervisor. This allows detection of unexpected stoppage of the hypervisor or a deadlock or a live-lock having occurred in the hypervisor. To apply this method, however, it is necessary to impose requirements related to updating of count by the counter on the hypervisor. In addition, because a count updating process by the watchdog timer is generally given high priority, when the priority of the count updating process is set higher than the processing priority of a task having developed deadlock or live-lock inside the hypervisor, the deadlock or the live-lock cannot be detected.

An object of the present invention is to monitor a hypervisor provided by a third party or the like, the hypervisor having its internal logic not made open to the public, and to detect abnormality having occurred in the hypervisor, based only on input to and output from the hypervisor.

### Solution to Problem

A typical example of the present invention disclosed herein is as follows. An electronic controller includes: a virtual machine that accesses a first virtual driver to execute a process; a hypervisor that calls a first real driver of a first peripheral, based on a peripheral access request received from the first virtual driver; an access recording unit that calls the first virtual driver to record a peripheral access request transmitted to the hypervisor; a state recording unit that calls the first real driver to record a state of a register of the first peripheral; and a monitoring unit that monitors an operation of the hypervisor. The monitoring unit determines an abnormality of the hypervisor, based on a record by the access recording unit and on a record by the state recording unit.

### Advantageous Effects of Invention

According to one aspect of the present invention, an abnormality of a hypervisor can be detected without accessing an internal state of the hypervisor. Problems, configurations, and effects that are not described above will be made clear by the following description of embodiments.

### BRIEF DESCRIPTION OF DRAWINGS

FIG. 1 depicts a hardware configuration of an electronic controller according to a first embodiment.

FIG. 2 depicts a software configuration of the electronic controller according to the first embodiment.

FIG. 3 depicts an outline of a process flow that is executed when a first control software application of the first embodiment uses a first peripheral.

FIG. 4 depicts an outline of a process flow that is executed when the first control software application of the first embodiment uses a shared peripheral.

FIG. 5 depicts an example of peripheral access request information according to the first embodiment.

FIG. 6 depicts an example of peripheral access result information of the first embodiment.

FIG. 7 depicts an outline of a process flow that is executed when a second control software application of the first embodiment uses a second peripheral.

FIG. 8 depicts an outline of a process flow that is executed when the second control software application of the first embodiment uses the shared peripheral.

FIG. 9 depicts an example of peripheral access record information according to the first embodiment.

FIG. 10 depicts an example of peripheral state record information according to the first embodiment.

FIG. 11 depicts an outline of a process flow of a hypervisor monitoring program of the first embodiment.

FIG. 12 depicts an example of peripheral intended state information according to the first embodiment.

FIG. 13 is a diagram schematically showing a process of generating the peripheral intended state information that is executed at step S1 of the hypervisor monitoring program of the first embodiment.

FIG. 14 is a diagram schematically showing the process of generating the peripheral intended state information that is executed at step S1 of the hypervisor monitoring program of the first embodiment.

FIG. 15 depicts a software configuration of an electronic controller according to a second embodiment.

FIG. 16 depicts an outline of a process flow of a hypervisor monitoring program of the second embodiment.

FIG. 17 depicts a hardware configuration of an electronic controller according to a third embodiment.

FIG. 18 depicts a software configuration of the electronic controller according to the third embodiment.

FIG. 19 depicts an outline of a process flow that is executed when the first control software application of the third embodiment uses a CAN controller that is the shared peripheral.

FIG. 20 depicts a CAN ledger of the third embodiment.

FIG. 21 depicts an outline of a process flow of a monitoring result storing program of a fourth embodiment.

FIG. 22 depicts an example of hypervisor abnormality occurrence time information of the fourth embodiment.

FIG. 23 is a diagram schematically showing an outline of a process executed at step S7 of the monitoring result storing program of the fourth embodiment.

### DESCRIPTION OF EMBODIMENTS

Embodiments described herein relate to an electronic controller, and particularly relates to an electronic controller in which a plurality of control software applications are integrated on one microcomputer.

Hereinafter, examples of preferred embodiments of the present invention will be described. In the embodiments, for convenience in description, an example in which two control software applications, i.e., a first control software application and a second control software application are integrated on one electronic controller will be explained. In a different example, however, a third control software application and a fourth control software application may be integrated on one electronic controller.

### First Embodiment

### <Configuration>

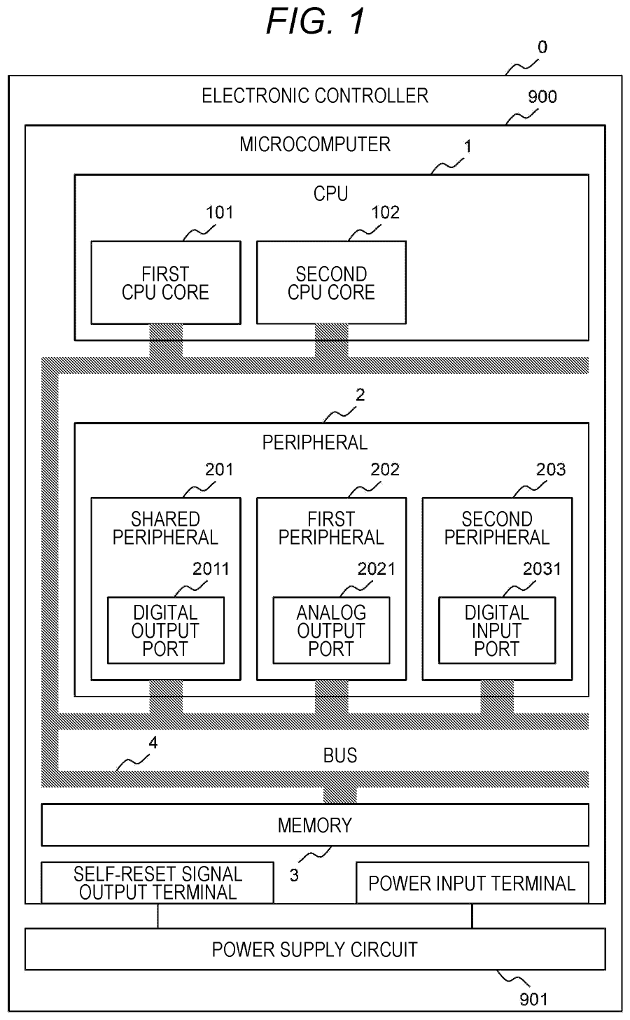

FIG. 1 depicts a hardware configuration of an electronic controller according to a first embodiment.

### <Electronic Controller 0>

The electronic controller according to the first embodiment will hereinafter be described with reference to FIG. 1. An electronic controller 0 includes a microcomputer 900 and a power supply circuit 901. The microcomputer 900 includes a central processing unit (CPU) 1 that carries out computation processes, a peripheral 2 that is a peripheral device group mounted on the electronic controller 0, a memory 3 storing software, and a bus 4 that interconnects the CPU 1, the peripheral 2, and the memory 3 and that allows the CPU 1 to access the peripheral 2 and the memory 3.

A power input terminal of the microcomputer 900 is connected to a power supply circuit 901. The microcomputer 900 starts up when supplied with power from the power supply circuit 901. The microcomputer 900 has a self-reset signal output terminal. When the microcomputer 900 outputs a digital signal from the self-reset signal output terminal, the power supply circuit 901 stops supplying power to the microcomputer 900.

### <CPU 1>

The CPU 1 includes two CPU cores, i.e., a first CPU core 101 and a second CPU core 102. It should be noted that two CPU cores are mentioned exemplarily for convenience in description. For example, the CPU 1 may include one CPU core or three or more CPU cores.

### <Peripheral 2>

The peripheral 2 is a device that inputs and outputs data/signals into or out of the microcomputer 900, and includes a shared peripheral 201 accessed by both a first control software application 10 (i.e., a first CPU core 101) and a second control software application 15 (i.e., a second CPU core 102), a first peripheral 202 accessed by the first control software application 10 (i.e., the first CPU core 101) only, and a second peripheral 203 accessed by the second control software application 15 (i.e., the second CPU core 103) only. The peripheral 2 generally refers to peripheral circuits, not including the CPU 1 and the memory 3, that are mounted on the microcomputer 900. The peripheral 2, specifically, includes a controller area network (CAN) controller, an analog/digital converter, a direct memory access controller, and a general purpose input/output (GPIO) that are mounted on the microcomputer 900.

### <Memory 3>

The memory 3 includes a ROM, which is a nonvolatile storage element, and a RAM, which is a volatile storage element. The ROM stores an unchangeable program (e.g., BIOS) and the like. The RAM is a volatile storage element allowing high-speed access, such as a dynamic random access memory (DRAM), storing programs executed by the CPU 1 and data used for execution of programs.

For simplicity, this embodiment will be described on the assumption that the shared peripheral 201 includes a digital output port 2011, the first peripheral 202 includes an analog output port 2021, and the second peripheral 203 includes a digital input port 2031.

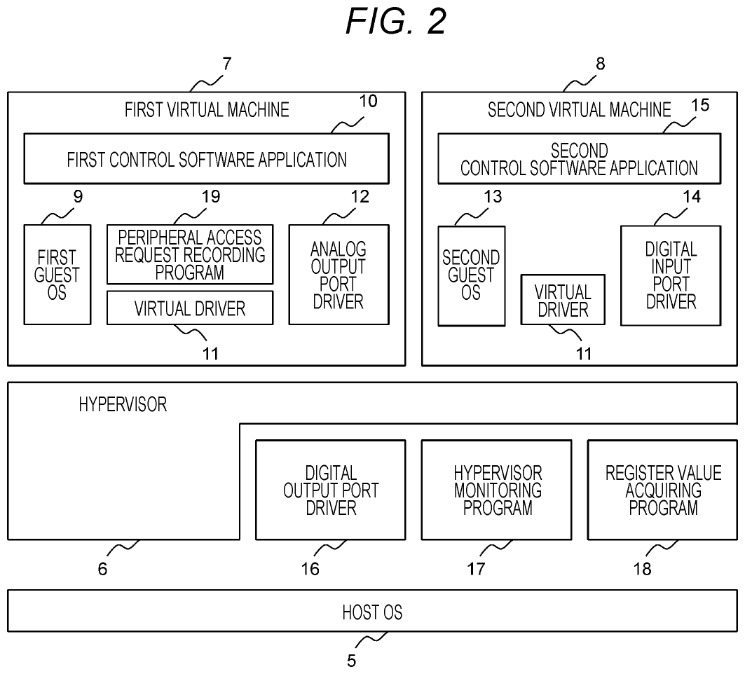

FIG. 2 depicts a software configuration of the electronic controller according to the first embodiment. Piece of software shown in FIG. 2 are stored in the memory 3.

### <Software Configuration>

The following process is executed at either the first CPU core 101 or the second CPU core 102 of the CPU 1.

A host operating system (OS) 5 is installed in the microcomputer 900. The host OS 5 activates a hypervisor 6, a hypervisor monitoring program 17, and a register value acquiring program 18. The hypervisor 6 is activated by an activation method defined by the hypervisor 6. The hypervisor monitoring program 17 and the register value acquiring program 18 are activated at a cycle of 5 milliseconds to acquire information for monitoring. For simplicity, the activation cycle is described as 5 milliseconds in this embodiment. Not limited to 5 milliseconds, however, a different activation cycle may also be adopted. The hypervisor 6 may be configured by software executed on the host OS 5 or by hardware mounted on the microcomputer 900.

The hypervisor 6 configures a first virtual machine 7 and a second virtual machine 8 by a method defined by the hypervisor 6, and activates each of the first virtual machine 7 and the second virtual machine 8. For simplicity, two virtual machines are described in this embodiment. Not limited to two, however, one or three or more virtual machines may be provided.

At the first virtual machine 7, a first guest OS 9, the first control software application 10, a virtual driver 11, a peripheral access request recording program 19, and an analog output port driver 12 are executed. At the second virtual machine 8, a second guest OS 13, the second control software application 15, the virtual driver 11, and a digital input port driver 14 are executed. The peripheral access request recording program 19 is executed on the first virtual machine 7, but may be executed on the second virtual machine 8. In other words, at least one peripheral access request recording program 19 being executed on the hypervisor 6 is sufficient.

### <First Virtual Machine 7>

Operation of software at the first virtual machine 7 will be described. When the hypervisor 6 configures the first virtual machine 7, the first virtual machine 7 activates the first guest OS 9. The first guest OS 9 activates the first control software application 10. The first control software application 10 uses the digital output port 2011, which is the shared peripheral 201, and the analog output port 2021, which is the first peripheral 202.

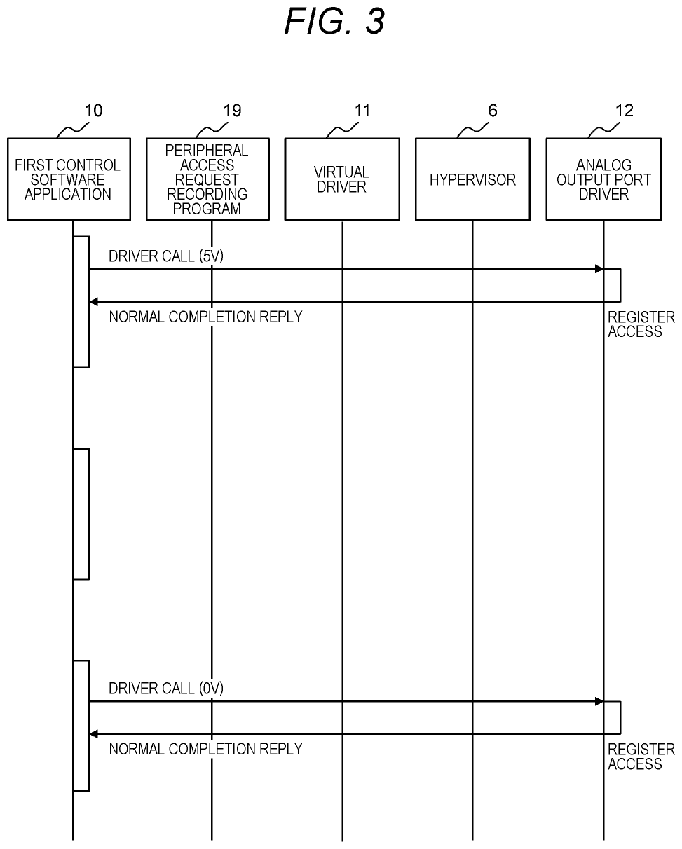

FIG. 3 depicts an outline of a process flow that is executed when the first control software application 10 uses the first peripheral 202.

<Access from First Virtual Machine 7 to First Peripheral 202>

To access the analog output port 2021, which is the first peripheral 202, the first control software application 10 uses the analog output port driver 12. Specifically, when the first control software application 10 calls the analog output port driver 12 by specifying a parameter of 5 V, the call being made as a peripheral access request, the analog output port driver 12 accesses a register of the analog output port 2021, enters a value for setting an output voltage of 5 V in a given place of a register of the microcomputer 900, and sends a reply indicative of normal completion to the first control software application 10.

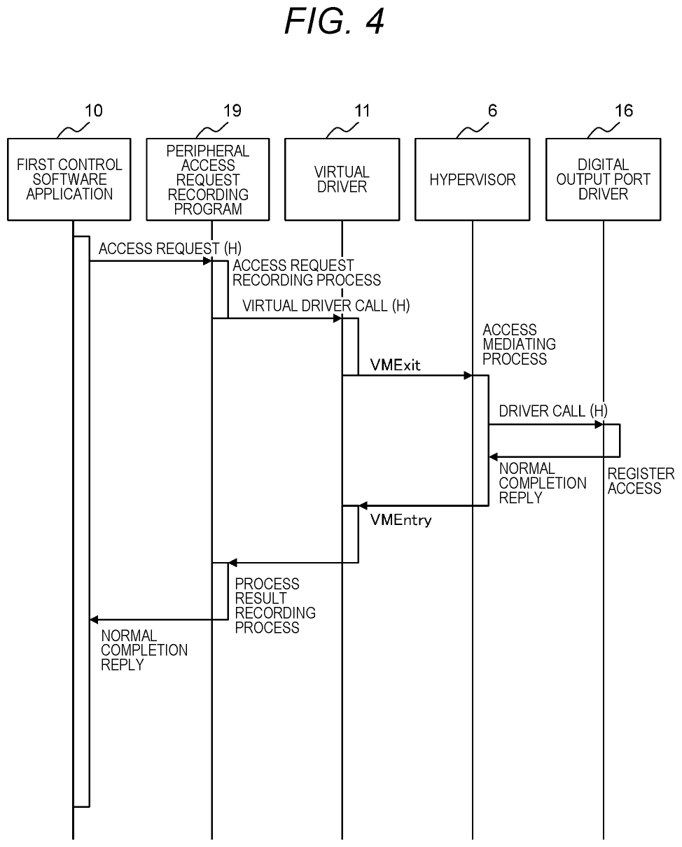

FIG. 4 depicts an outline of a process flow that is executed when the first control software application 10 uses the shared peripheral 201.

<Access from First Virtual Machine 7 to Shared Peripheral 201>

To access the digital output port 2011, which is the shared peripheral 201, the first control software application 10 uses the peripheral access request recording program 19, the virtual driver 11, the hypervisor 6, and the digital output port driver 16. Specifically, the first control software application 10 calls the peripheral access request recording program 19 by specifying a parameter of H, the call being made as a peripheral access request. The peripheral access request recording program 19 records peripheral access request information 51 by the first control software application 10, and calls the virtual driver 11 by specifying a parameter of H. The virtual driver 11 executes a process of changing a processing context of the CPU 1 from the first virtual machine 7 to the hypervisor 6 (which process is generally referred to as VMExit). The hypervisor 6 checks a use status of the digital output port 2011. When finding that the second virtual machine 8 is not using the digital output port 2011, the hypervisor 6 calls the digital output port driver 16 for accessing the digital output port 2011 by specifying a parameter of H. When finding that the second virtual machine 8 is using the digital output port 2011, the hypervisor 6 stores the parameter H in a buffer provided in the hypervisor 6 and stands by, takes the parameter H out of the buffer after the second virtual machine 8 finishes using the digital output port 2011, and then calls the digital output port driver 16 by attaching the taken out parameter to the call.

The digital output port driver 16 accesses a register of the digital output port 2011, enters a value for setting an output value of H (High or 1) in a given place of the register of the microcomputer 900, and sends a reply indicative of normal completion back to the hypervisor 6. Upon receiving the reply indicative of normal completion from the digital output port driver 16, the hypervisor 6 executes a process of changing the processing context of the CPU 1 from the hypervisor 6 to the first virtual machine 7 (which process is generally referred to as VMEntry). When receiving information indicating normal completion from the hypervisor 6, the virtual driver 11 calls the peripheral access request recording program 19. The peripheral access request recording program 19 records peripheral access result information 52 on the first control software application 10, and sends a reply indicative of normal completion to the first control software application 10.

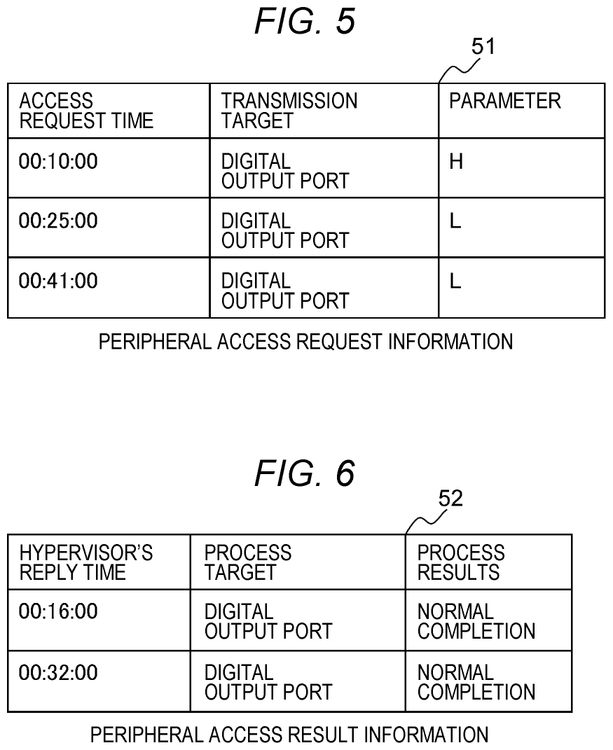

FIG. 5 depicts an example of the peripheral access request information 51 by the first control software application 10.

### <Peripheral Access Request Information 51 by First Control Software Application 10>

The peripheral access request information 51 by the first control software application 10 includes information on a time at which the first control software application 10 has called the peripheral access request recording program 19, on a peripheral to which an access request is made by the call, and on a parameter specified by the call.

FIG. 6 depicts an example of the peripheral access result information 52 on the first control software application 10.

### <Peripheral Access Result Information 52 on First Control Software Application 10>

The peripheral access result information 52 on the first control software application 10 includes information on a time at which the hypervisor 6 has sent a reply indicative of normal completion of a process back to the virtual driver 11, on a peripheral which is subjected to a process by the hypervisor 6, and on process results.

### <Second Virtual Machine 8>

Operation of software at the second virtual machine 8 will be described. When the hypervisor 6 configures the second virtual machine 8, the second virtual machine 8 activates the second guest OS 13. The second guest OS 13 activates the second control software application 15. The second control software application 15 uses the digital output port 2011, which is the shared peripheral 201, and the digital input port 2031, which is the second peripheral 203.

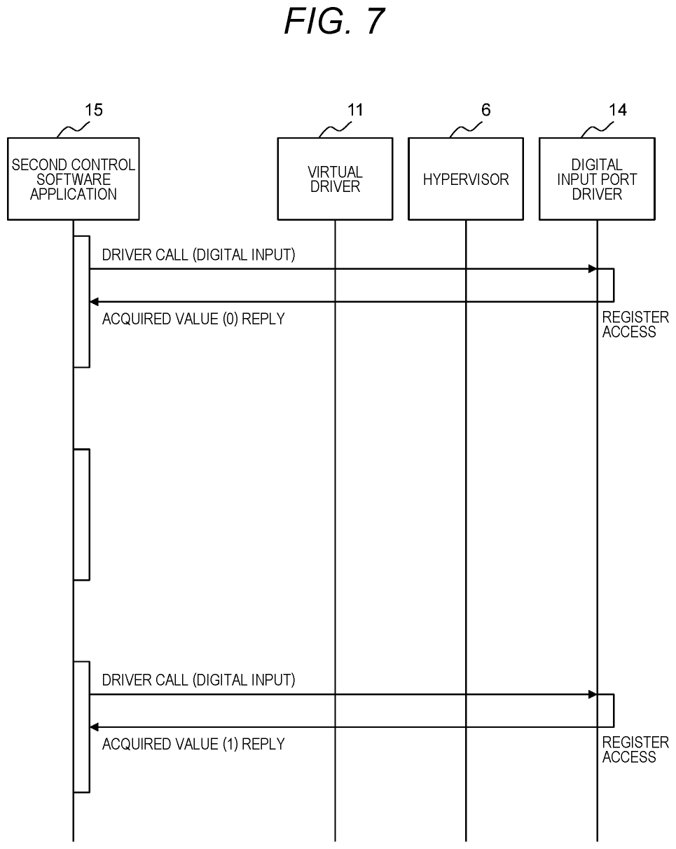

FIG. 7 depicts an outline of a process flow that is executed when the second control software application 15 uses the second peripheral 203.

<Access from Second Virtual Machine 8 to Second Peripheral 203>

To access the digital input port 2031, which is the second peripheral 203, the second control software application 15 uses the digital input port driver 14. Specifically, when the second control software application 15 calls the digital input port driver 14, the call being made as a peripheral access request, the digital input port driver 14 accesses a register of the digital input port 2031, reads a value in a given place of the register of the microcomputer 900, and sends a reply with the read value attached thereto back to the second control software application 15.

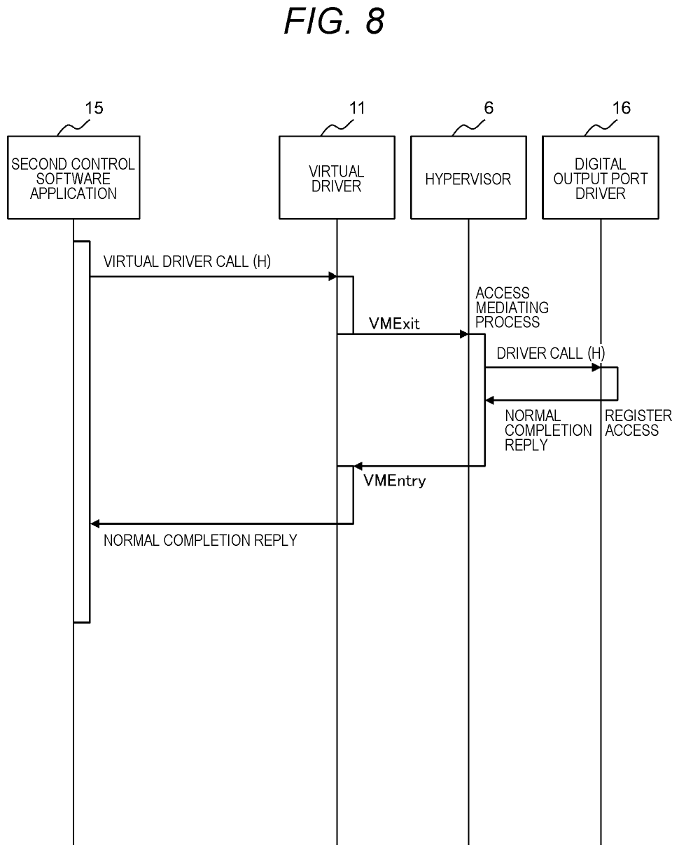

FIG. 8 depicts an outline of a process flow that is executed when the second control software application 15 uses the shared peripheral 201.

<Access from Second Virtual Machine 8 to Shared Peripheral 201>

To access the digital output port 2011, which is the shared peripheral 201, the second control software application 15 uses the virtual driver 11, the hypervisor 6, and the digital output port driver 16. Specifically, the first control software application 10 calls the virtual driver 11 by specifying a parameter of H, the call being made as a peripheral access request. The virtual driver 11 executes a process of changing a processing context of the CPU 1 from the second virtual machine 8 to the hypervisor 6 (which process is generally referred to as VMExit). The hypervisor 6 checks a use status of the digital output port 2011. When finding that the first virtual machine 7 is not using the digital output port 2011, the hypervisor 6 calls the digital output port driver 16 for accessing the digital output port 2011 by specifying a parameter of H. When finding that the first virtual machine 7 is using the digital output port 2011, the hypervisor 6 stores the parameter H in the buffer provided in the hypervisor 6 and stands by, takes the parameter H out of the buffer after the first virtual machine 7 finishes using the digital output port 2011, and then calls the digital output port driver 16 by attaching the taken out parameter to the call.

The digital output port driver 16 accesses a register of the digital output port 2011, enters a value for setting an output value of H (High or 1) in a given place of the register of the microcomputer 900, and sends a reply indicative of normal completion back to the hypervisor 6. Upon receiving the reply indicative of normal completion from the digital output port driver 16, the hypervisor 6 executes a process of changing the processing context of the CPU 1 from the hypervisor 6 to the first virtual machine 7 (which process is generally referred to as VMEntry). When receiving information indicating normal completion from the hypervisor 6, the virtual driver 11 sends a reply indicative of normal completion back to the first control software application 10.

### <Peripheral Access Request Recording Program 19>

As shown in FIG. 4, when the first control software application 10 sends out a peripheral access request, the peripheral access request recording program 19 generates the peripheral access request information 51 on access requests by the first control software application 10. As shown in FIG. 4, when the virtual driver 11 receives information indicating normal completion from the hypervisor 6, the peripheral access request recording program 19 generates the peripheral access result information 52 on the first control software application 10. Further, the peripheral access request recording program 19 is repeatedly activated by the first guest OS 9 at a given timing (e.g., at a cycle of 100 milliseconds), generates peripheral access record information 53 in which the peripheral access request information 51 by the first control software application 10 and the peripheral access result information 52 on the first control software application 10 are integrated, and writes the peripheral access record information 53 to a memory area that the hypervisor monitoring program 17 can refer to.

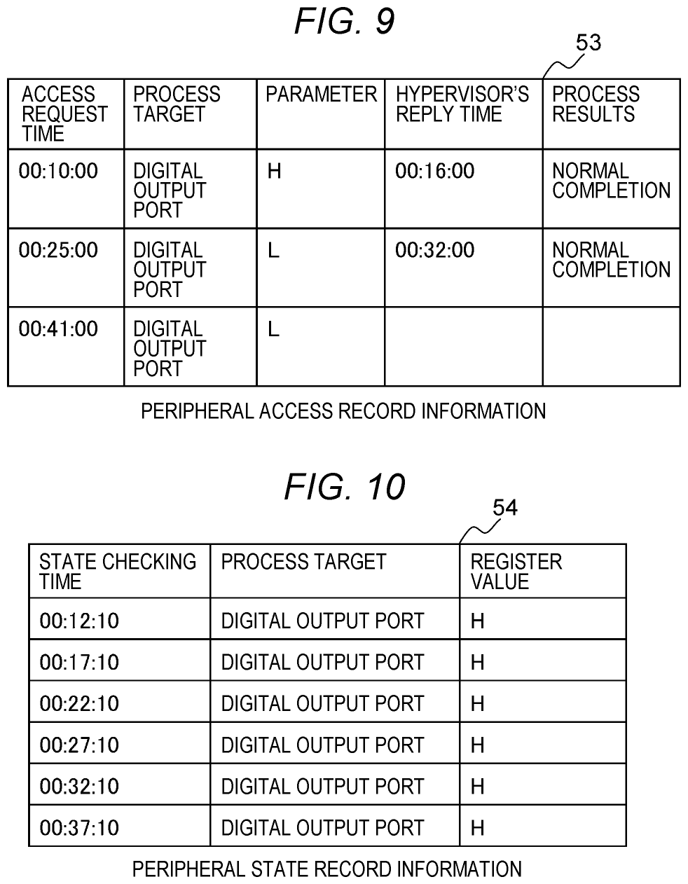

FIG. 9 depicts an example of the peripheral access record information 53.

### <Peripheral Access Record Information 53>

The peripheral access record information 53 includes information on a time at which the first control software application 10 has called the peripheral access request recording program 19, on a peripheral to which access is made by a peripheral access request, on a parameter attached to the peripheral access request, on a time at which according to the peripheral access request, the hypervisor 6 has sent information indicating normal completion of a process to the virtual driver 11, and on process results by the hypervisor 6.

### <Register Value Acquiring Program 18>

The register value acquiring program 18 is activated repeatedly by the host OS 5 at a given timing (e.g., at a cycle of 5 milliseconds). Every time being activated, the register value acquiring program 18 calls the digital output port driver 16 to acquire a value in a given place of the register of the microcomputer 900, the value representing a state of the digital output port 2011 that is the shared peripheral 201, generates peripheral state record information 54, and writes the generated peripheral state record information 54 to a memory area that the hypervisor monitoring program 17 can refer to. The register value acquiring program 18 is executed on the host OS 5, but may be executed on the hypervisor 6.

FIG. 10 depicts an example of the peripheral state record information 54.

### <Peripheral State Record Information 54>

The peripheral state record information 54 includes information on a process target peripheral which is subjected to a process by the register value acquiring program 18, on a time at which the register value acquiring program 18 has called the peripheral (the digital output port driver 16), and on a register value acquired by the call.

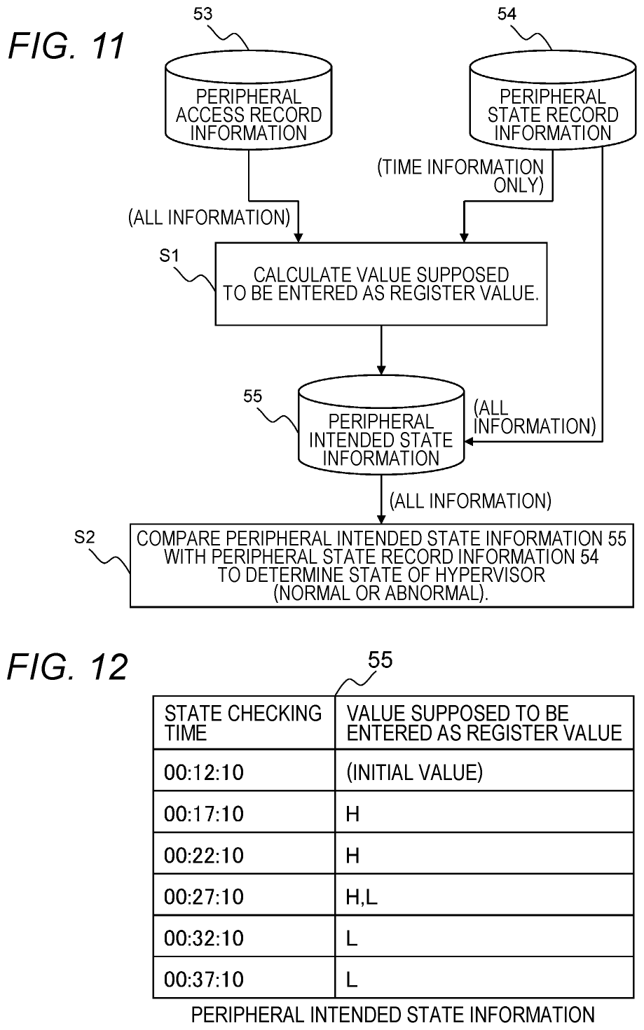

FIG. 11 depicts an outline of a process flow of the hypervisor monitoring program 17.

### <Hypervisor Monitoring Program 17>

The hypervisor monitoring program 17 calculates a value supposed to be entered as a register value, based on the peripheral access record information 53, and when the value supposed to be entered as the register value does not match the corresponding value indicated by the peripheral state record information 54, determines that an abnormality has occurred in the hypervisor 6.

At step S1, the hypervisor monitoring program 17 generates peripheral intended state information 55, based on all pieces of information making up the peripheral access record information 53 and on state check time information included in the peripheral state record information 54.

At step S2, the hypervisor monitoring program 17 compares the peripheral state record information 54 with the peripheral intended state information 55, and determines whether the hypervisor 6 is in a normal state or in an abnormal state.

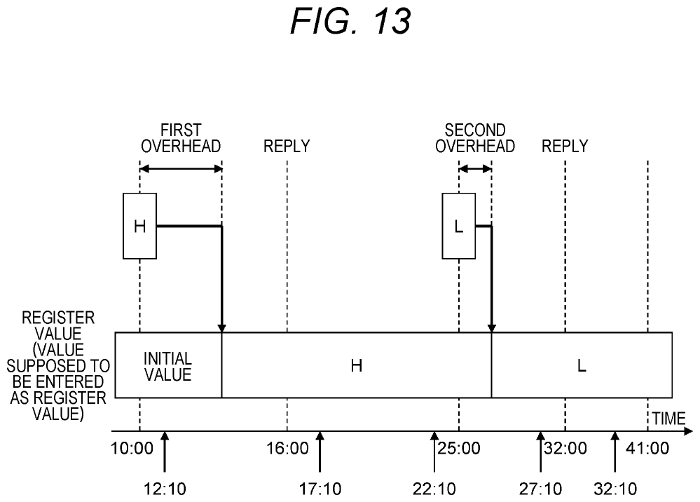

FIG. 12 depicts an example of the peripheral intended state information 55.

### <Peripheral Intended State Information 55>

The peripheral intended state information 55 includes information on a time at which the register value acquiring program 18 has called the digital output port driver 16, and on a peripheral register value at a time that is calculated based on the peripheral access record information 53.

FIG. 13 is a diagram schematically showing a process of generating the peripheral intended state information that is executed at step S1 of the hypervisor monitoring program 17.

### <Step S1>

In this embodiment, an initial value for the register is an unfixed value.

According to the peripheral access record information 53, the first control software application 10 transmits a peripheral access request with a specified parameter H, at 10:00. Now, an overhead time exists in a period between transmission of the peripheral access request by the first control software application 10 and actual processing of a register value of the digital output port driver 16 according to the flow shown in FIG. 4. The length of the overhead time cannot be predicted. Nevertheless, by referring to a hypervisor's reply time indicated in the peripheral access record information 53, it is inferred that the register value is set to H at any point of time between 10:00 and 16:00.

Similarly, according to the peripheral access record information 53, the first control software application 10 transmits a peripheral access request with a specified parameter L, at 25:00. Now, an overhead time exists in a period between transmission of the peripheral access request by the first control software application 10 and actual processing of a register value of the digital output port driver 16 according to the flow shown in FIG. 4. The length of the overhead time cannot be predicted. Nevertheless, by referring to a hypervisor's reply time indicated in the peripheral access record information 53, it is inferred that the register value is set to L at any point of time between 25:00 and 32:00.

Hence the peripheral intended state information 55 shown in FIG. 12 is generated. Specifically, at 12:10, either the initial value, i.e., an unfixed value, being maintained or H being entered as the register value accordance to the peripheral access request transmitted at 10:00 results, which means that both register value of H and register value of L could result. At 17:10, a time behind 16:00, the register value is H, which results also at 22:10. At 27:10, however, either the register value remaining H or the register value switching to L accordance to the peripheral access request transmitted at 25:00 results, which means that both register value of H and register value of L could result. At 32:10, a time behind 32:00, the register value is L, which results also at 37:10.

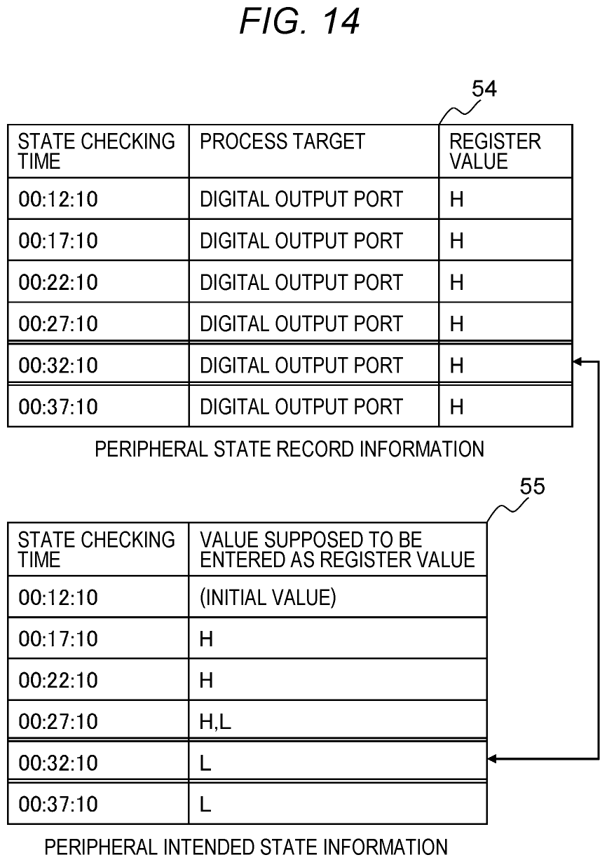

FIG. 14 is a diagram schematically showing the process of generating the peripheral intended state information that is executed at step S1 of the hypervisor monitoring program 17.

### <Step S2>

At step S2, the hypervisor monitoring program 17 compares the peripheral intended state information 55 with the peripheral state record information 54, and determines that an abnormality has occurred in the hypervisor 6 when the a peripheral register value at each calculated time in the peripheral intended state information 55 is different from the corresponding register value recorded in peripheral state record information 54. Specifically, as indicated in FIG. 14, the register value at 32:10 is supposed to be L according to the peripheral intended state information 55, but the actual register value at 32:10 is H according to the peripheral state record information 54. This demonstrates a fact that an abnormality has occurred in the hypervisor 6, which means detection of an abnormality. This indicates a case where the first control software application 10 has sent a peripheral access request for setting a register value of the digital output port 2011 to L and the hypervisor 6 has sent a reply indicative of normal completion of a process back to the first control software application 10 but in fact the register value of the digital output port 2011 is not changed, that is, remains H.

According to this embodiment, even in the case of the hypervisor 6 whose internal logic is not made open to the public, by using a record of changes in register values of the microcomputer 900 operated by the hypervisor 6, whether the hypervisor 6 correctly executes processes requested by the control software applications 10 and 15 inside the virtual machines 7 and 8 is monitored from outside of the hypervisor 6. By this process, an abnormality of the hypervisor 6 can be detected, based on input to and output from the hypervisor 6, without accessing an internal state of the hypervisor 6. Even in a case where the hypervisor 6 sends a reply indicative of completion of a normal process back to the virtual machines 7 and 8, if the process is in fact not executed normally, that fact can be detected as an abnormality of the hypervisor 6.

In addition, because an abnormality of the hypervisor 6 is determined based on the inconsistency between an actual value of the register and a preset value, an extra process, such as a test pattern, is unnecessary, which reduces a negative effect on a main process.

### Second Embodiment

An electronic controller and an abnormality detection method according to a second embodiment of the present invention will be described. The second embodiment is different from the first embodiment in that a monitoring result storing program 20 is added to a software configuration. The same constitutional elements as those of the first embodiment will be denoted by the same reference signs and will be omitted in further description.

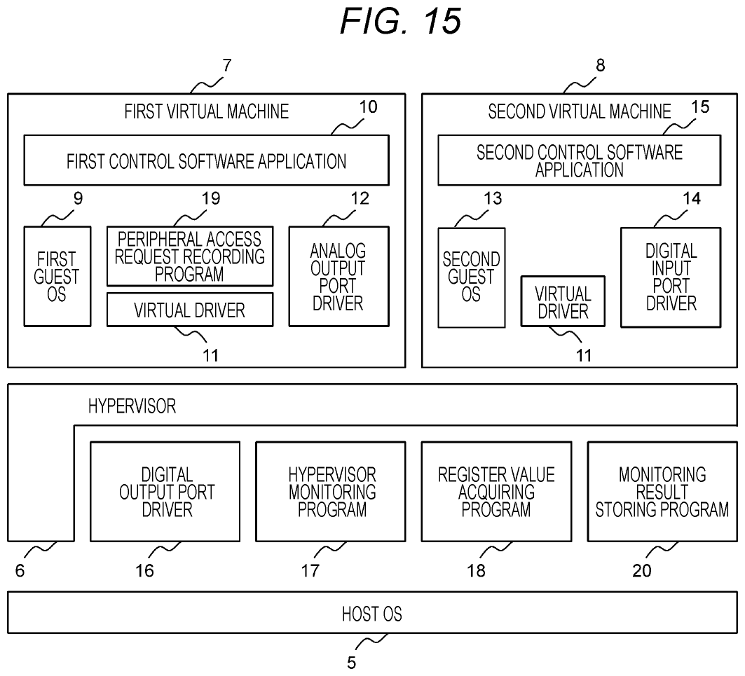

FIG. 15 depicts a software configuration of the electronic controller according to the second embodiment. Pieces of software shown in FIG. 15 are stored in the memory 3.

### <Software Configuration>

The host OS 5 is installed in the microcomputer 900. The host OS 5 activates a hypervisor 6, a hypervisor monitoring program 17, and a register value acquiring program 18. The host OS 5 repeatedly checks a value of the abnormality detection flag 56 at a given timing (e.g., at a cycle of 5 milliseconds), and when confirming that the value of the abnormality detection flag 56 is True, rewrites the value of the abnormality detection flag 56 to False and then starts the monitoring result storing program 20.

### <Abnormality Detection Flag 56>

The abnormality detection flag 56 is a variable that takes one of two values: True and False.

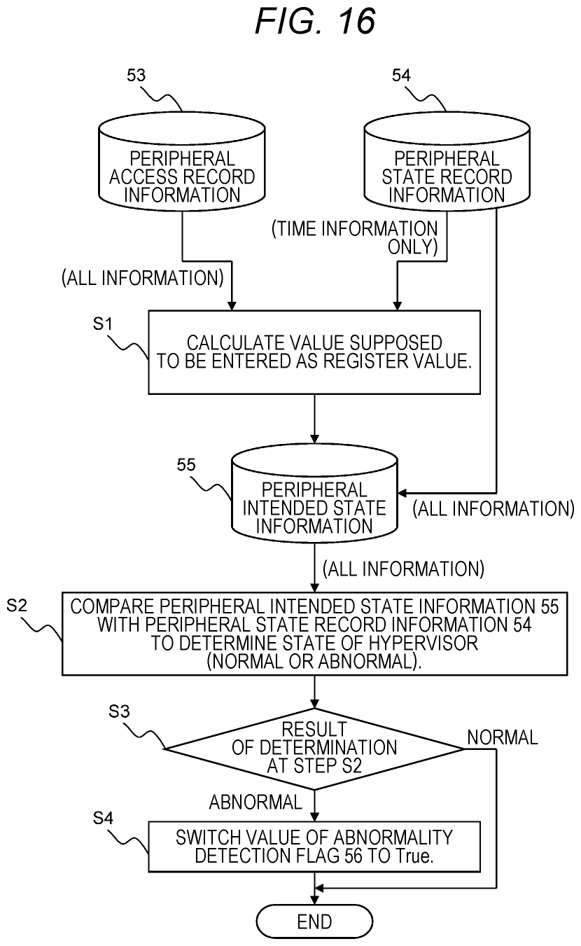

FIG. 16 depicts an outline of a process flow of the hypervisor monitoring program 17.

### <Step S3>

At step S3, the hypervisor monitoring program 17 causes the process flow to branch, depending on whether a determination result at step S2 is a normal state or an abnormal state, In other words, the hypervisor monitoring program 17 ends the process flow without doing anything when the determination result at step S2 is a normal state, but proceeds to step S4 when the determination result at step S2 is an abnormal state.

### <Step S4>

At step S4, the hypervisor monitoring program 17 switches a value of the abnormality detection flag 56 to True, and ends the process flow.

### <Monitoring Result Storing Program 20>

The monitoring result storing program 20 stores the peripheral access record information 53, the peripheral state record information 54, and the peripheral intended state information 55 in a nonvolatile memory area inside the memory 3 of the microcomputer 900.

According to this embodiment, by referring to the nonvolatile memory area, the peripheral access record information 53, the peripheral state record information 54, and the peripheral intended state information 55 can be used as information for debugging that identifies the reason why an abnormality is detected in the hypervisor 6 and an operation pattern that causes the hypervisor 6 an abnormality.

### Third Embodiment

An electronic controller and an abnormality detection method according to a third embodiment of the present invention will be described. The third embodiment is different from the first embodiment in that a different virtual driver is used to extract the peripheral access record information 53. The same constitutional elements as those of the first embodiment will be denoted by the same reference signs and will be omitted in further description.

### <Configuration>

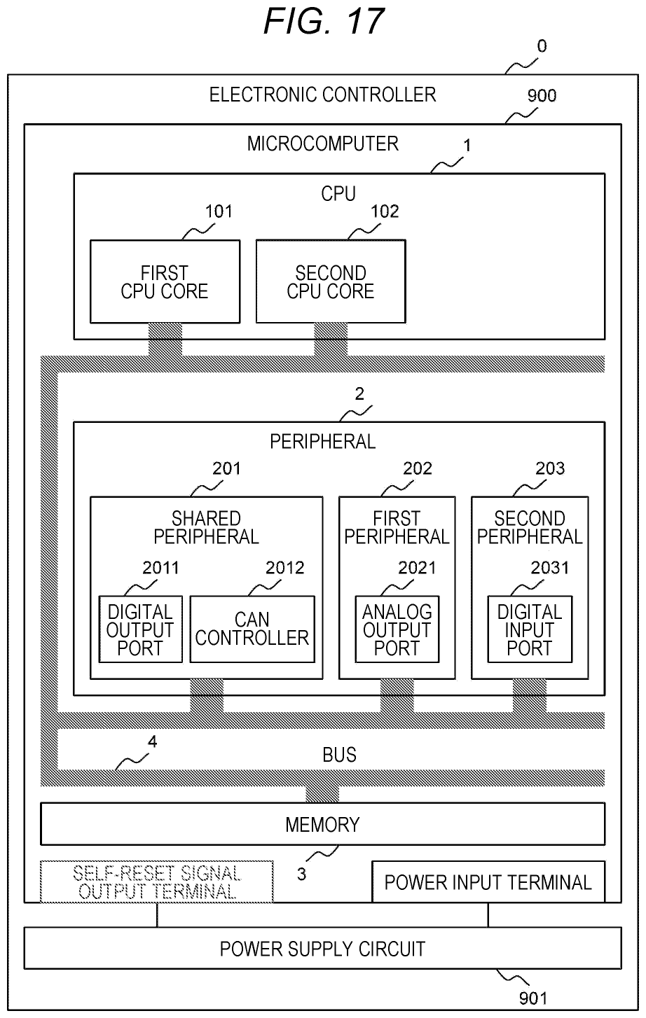

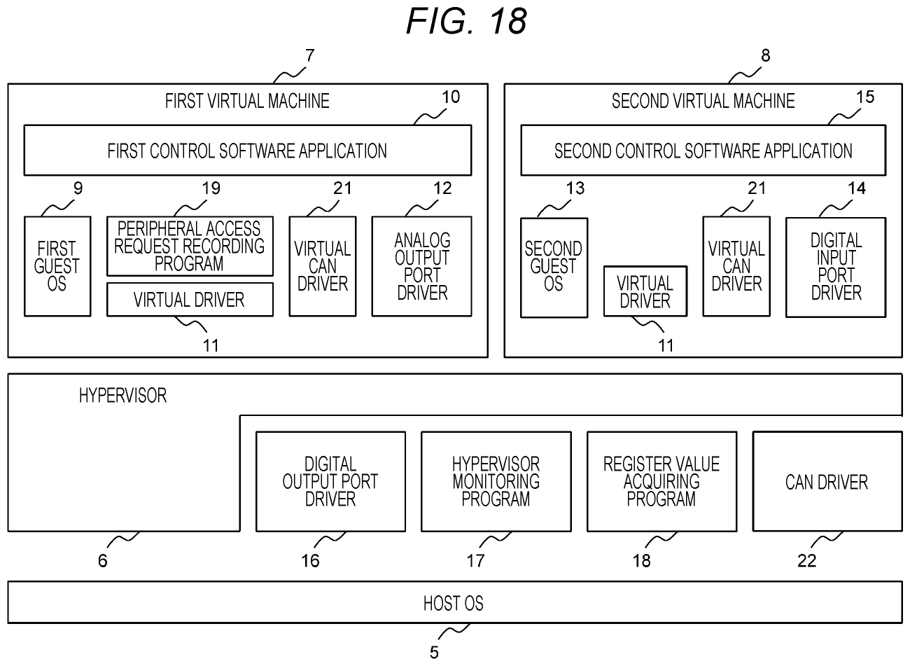

FIG. 17 depicts a hardware configuration of the electronic controller according to the third embodiment.

### <Peripheral 2>

In this embodiment, the shared peripheral 201 includes the digital output port 2011 and a CAN controller 2012, the first peripheral 202 includes the analog output port 2021, and the second peripheral 203 includes the digital input port 2031.

FIG. 18 depicts a software configuration of the electronic controller according to the third embodiment. Pieces of software shown in FIG. 18 are stored in the memory 3.

### <Software Configuration>

The first virtual machine 7 includes the first guest OS 9, the first control software application 10, the virtual driver 11, the peripheral access request recording program 19, the analog output port driver 12, and a virtual CAN driver 21. The second virtual machine 8 includes the second guest OS 13, the second control software application 15, the virtual driver 11, the digital input port driver 14, and a virtual CAN driver 21.

### <First Virtual Machine 7>

Operation of software at the first virtual machine 7 will be described. When the hypervisor 6 configures the first virtual machine 7, the first virtual machine 7 activates the first guest OS 9. The first guest OS 9 activates the first control software application 10. The first control software application 10 uses the digital output port 2011 and the CAN controller 2012, which make up the shared peripheral 201, and the analog output port 2021, which is the first peripheral 202.

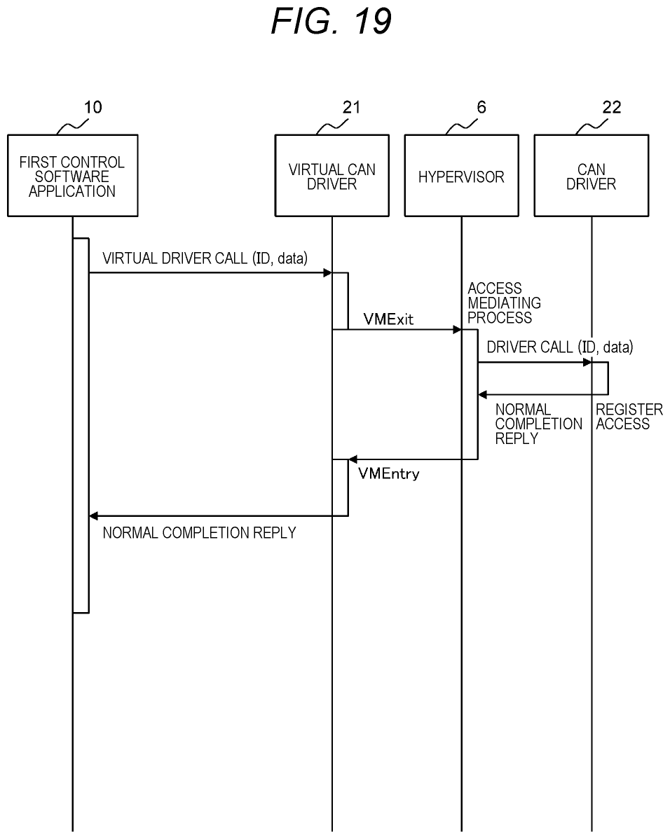

FIG. 19 depicts an outline of a process flow that is executed when the first control software application 10 of the third embodiment uses the CAN controller 2012 that is the shared peripheral 201.

<Access from First Virtual Machine 7 to CAN Controller 2012>

To access the CAN controller 2012, which is the shared peripheral 201, the first control software application 10 uses the virtual CAN driver 21, the hypervisor 6, and a CAN driver 22. Specifically, the first control software application 10 calls the virtual CAN driver 21 by specifying an ID assigned in conformity with a CAN message protocol and data to be transmitted to a CAN frame, as parameters, the call being made as a peripheral access request. The virtual CAN driver 21 executes a process of changing a processing context of the CPU 1 from the first virtual machine 7 to the hypervisor 6 (which process is generally referred to as VMExit). The hypervisor 6 checks a use status of the CAN controller 2012. When finding that the second virtual machine 8 is not using the CAN controller 2012, the hypervisor 6 calls the CAN driver 22 for accessing the CAN controller 2012 by specifying the ID and data as the parameters. When finding that the second virtual machine 8 is using the CAN controller 2012, the hypervisor 6 stores the ID and data in the buffer provided in the hypervisor 6 and stands by, takes the ID and data out of the buffer after the second virtual machine 8 finishes using the CAN controller 2012, and then calls the CAN driver 22 by attaching the taken out parameters to the call.

The CAN driver 22 accesses a register of the CAN controller 2012, stores the ID and data in a CAN frame and transmits the CAN frame through a CAN communication bus, and then sends a reply indicative of normal completion back to the hypervisor 6. Upon receiving the reply indicative of normal completion from the CAN driver 22, the hypervisor 6 executes a process of changing the processing context of the CPU 1 from the hypervisor 6 to the first virtual machine 7 (which process is generally referred to as VMEntry). When receiving information indicating normal completion from the hypervisor 6, the virtual CAN driver 21 sends a reply indicative of normal completion back to first control software application 10.

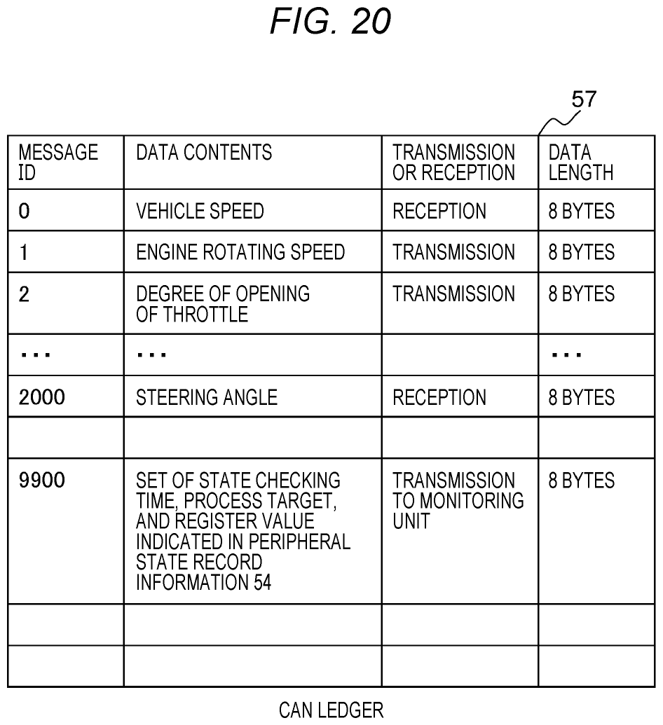

FIG. 20 depicts a CAN ledger 57 of the third embodiment.

### <CAN Ledger 57>

The CAN ledger 57, which is held inside the CAN driver 22, includes information on a message ID for identifying each CAN frame, on data contents representing the contents of data included in the CAN frame, on whether the CAN frame being transmitted or the CAN frame being received, and on a data length in the CAN frame. In this embodiment, CAN frames with IDs ranging from 0 to 2000 are used for ordinary control processes, and are transmitted to or received from the CAN communication bus. In a CAN frame with a message ID 9900, a set of a state checking time, a process target, and a register value indicated in the peripheral state record information 54 are stored as 8-byte data, and information on whether the CAN frame being transmitted or the CAN frame being received is entered as “transmission to monitoring unit”.

### <CAN Driver 22>

The CAN driver 22 operates a register of the CAN controller 2012 according to information entered in the CAN ledger 57. Specifically, the CAN driver 22 receives, by operating the register of the CAN controller 2012, 8-byte data of a CAN frame with a message ID 0 from the CAN communication bus, vehicle as speed, transmits, by operating the register of the CAN controller 2012, 8-byte data of a CAN frame with a message ID 1 to the CAN communication bus, as engine rotating speed, and transmits, by operating the register of the CAN controller 2012, 8-byte data of a CAN frame with a message ID 2 to the CAN communication bus, as degree of opening of throttle.

As to data of a CAN frame with a message ID 9900 whose information about whether being transmitted or received is entered as “transmission to monitoring unit” in the CAN ledger 57, the CAN driver 22 does not operate the register of the CAN controller 2012 but writes the data to a memory area the hypervisor monitoring program 17 can refer to. Being present outside the first virtual machine 7 and the hypervisor 6, the CAN driver 22 does not receive the reference of limitation to a reference space in the memory area that is placed by the hypervisor 6. In addition, using a peripheral (the digital output port 2011) used for monitoring the hypervisor 6 and another peripheral (the CAN controller 2012) allows the hypervisor 6 to store the peripheral access record information 53 in the memory area the hypervisor monitoring program 17 can refer to when an abnormality occurs during operation of the digital output port 2011.

According to this embodiment, even in a case where access from the inside of the virtual machine configured by the hypervisor 6 to the outside of the virtual machine is prohibited and consequently the peripheral access request recording program 19 cannot write the peripheral access record information 53 to the memory area the hypervisor monitoring program 17 can refer to, the peripheral access record information 53 can be taken out of the first virtual machine 7 and written to the memory area the hypervisor monitoring program 17 can refer to.

### Fourth Embodiment

An electronic controller and an abnormality detection method according to a fourth embodiment of the present invention will be described. The fourth embodiment is different from the second embodiment in that the electronic controller is shut down when a failure of the hypervisor 6 is detected at a frequency equal to or larger than a given value. The same constituent elements as those of the second embodiment will be denoted by the same reference signs and will be omitted in further description.

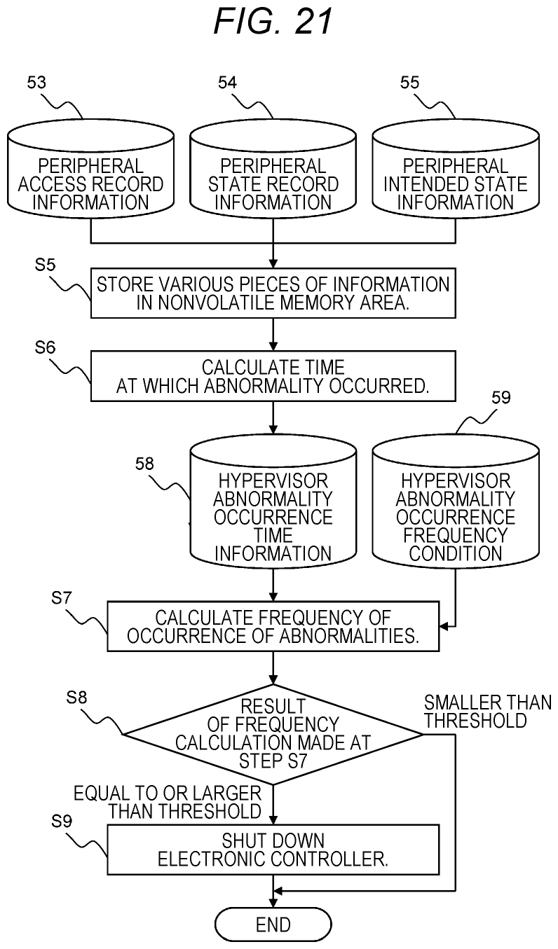

FIG. 21 depicts an outline of a process flow of a monitoring result storing program 20 of the fourth embodiment.

### <Monitoring Result Storing Program 20>

The monitoring result storing program 20 stores the peripheral access record information 53, the peripheral state record information 54, and the peripheral intended state information 55 in a nonvolatile memory area inside the memory 3 of the microcomputer 900, calculates the frequency of occurrence of abnormalities in the hypervisor 6, and when the calculated frequency of occurrence of abnormalities is equal to or higher than a given threshold, shuts down the electronic controller 0.

### <Step S5>

At step S5, the monitoring result storing program 20 stores the peripheral access record information 53, the peripheral state record information 54, and the peripheral intended state information 55 in the nonvolatile memory area inside the memory 3 of the microcomputer 900.

### <Step S6>

At step S6, the monitoring result storing program 20 calculates a time at which an abnormality occurred in the hypervisor 6. Because it is difficult to specify the time at which the abnormality actually occurred in the hypervisor 6 from outside the hypervisor 6, a time indicated in the peripheral state record information 54 and the peripheral intended state information 55, the time being taken by the hypervisor monitoring program 17 to be grounds for determining the occurrence of an abnormality in the hypervisor 6, is determined to be the time at which the abnormality occurred in the hypervisor 6. Specifically, as indicated in the peripheral state record information 54 and the peripheral intended state information 55 shown in FIG. 14, the time at which the abnormality occurred in the hypervisor 6 is calculated as 00:32:10. The monitoring result storing program 20 stores the calculated time, i.e., 00:32:10 in hypervisor abnormality occurrence time information 58.

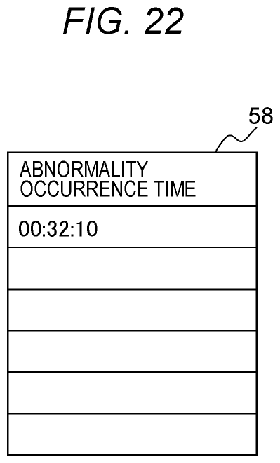

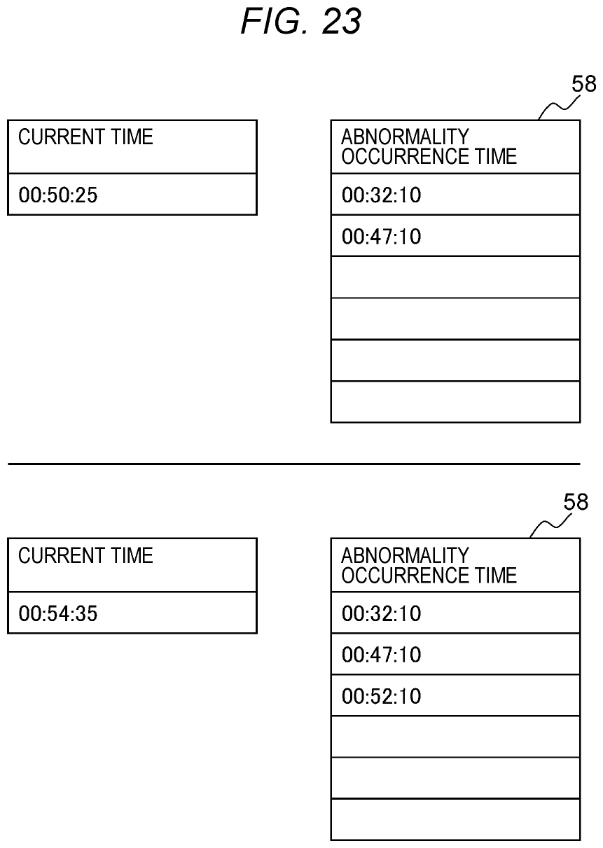

FIG. 22 depicts example of the hypervisor abnormality occurrence time information 58 of the fourth embodiment.

### <Hypervisor Abnormality Occurrence Time Information 58>

The hypervisor abnormality occurrence time information 58 stores information on a time calculated at step S6 of the monitoring result storing program 20 of the electronic controller of the fourth embodiment.

### <Hypervisor Abnormality Occurrence Frequency Condition 59>

A hypervisor abnormality occurrence frequency condition 59 is a condition for shutting down the electronic controller 0. In this embodiment, this condition specifies an abnormality of the hypervisor 6 being detected twice within a timespan 10:00 as a condition for shutdown.

FIG. 23 is a diagram schematically showing an outline of a process executed at step S7 of the monitoring result storing program 20 of the fourth embodiment.

### <Step S7>

At step S7, the monitoring result storing program 20 calculates the frequency of occurrence of abnormalities in the hypervisor 6. Since the hypervisor abnormality occurrence frequency condition 59 sets the frequency of occurrence of abnormalities in the hypervisor 6 within the timespan 10:00 as a shutdown condition, records of hypervisor abnormality occurrence time within the timespan 10:00 extending backward from the latest abnormality occurrence time are counted. This process will be described with reference to FIG. 23. At the point of 50:25, the latest abnormality occurrence time is 47:10, and the number of times of occurrence of abnormalities within the timespan 10:00 extending backward from 47:10, that is, within the period between 37:10 and 47:10 is 1 according to the hypervisor abnormality occurrence time information 58, and therefore the frequency within the timespan is determined to be 1. At the point of 54:35, the latest abnormality occurrence time is 52:10, and the number of times of occurrence of abnormalities within the timespan 10:00 extending backward from 52:10, that is, within the period between 42:10 and 52:10 is 2 according to the hypervisor abnormality occurrence time information 58, and therefore the frequency within the timespan is determined to be 2.

### <Step S8>

At step S8, when the frequency of occurrence of abnormalities determined at step S7 is equal to or larger than a threshold frequency defined by the hypervisor abnormality occurrence frequency condition 59, the monitoring result storing program 20 proceeds to step S9. Otherwise, the monitoring result storing program 20 skips step S9 and ends the process flow.

### <Step S9>

At step S9, the monitoring result storing program 20 outputs a reset signal from the self-reset output terminal of the microcomputer 900. As a result, the power supply circuit 901 stops supplying power to the microcomputer 900, which shuts down the electronic controller 0. The electronic controller 0 is partially shut down or entirely shut down.

According to this embodiment, when the frequency of detection of abnormalities in the hypervisor 6 is low, the electronic controller is kept in operation to suppress influences on the electronic controller and a vehicle in which the electronic controller is incorporated. When the frequency of detection of abnormalities in the hypervisor 6 is high, on the other hand, the electronic controller is shut down to reduce influences the abnormalities occurred in the hypervisor 6 exert on the safety of the electronic controller and the vehicle in which the electronic controller is incorporated. Hence both usability and safety can be ensured.

The present invention is not limited to the above embodiments, and includes various modifications and configurations equivalent to the embodiments that are within the scope of the appended claims. For example, the above embodiments have been described in detail to facilitate understanding of the present invention, and the present invention is not necessarily limited to an embodiment including all constituent elements described above. Some constituent elements of a certain embodiment may be replaced with constituent elements of another embodiment. A constituent element of another embodiment may be added to a constituent element of a certain embodiment. Some constituent elements of each embodiment may be deleted, or add to or replaced with constituent elements of another embodiment.

Some or all of the above constituent elements, functions, processing units, process means, and the like may be provided in the form of hardware by packaging them in an integrated circuit, or in the form of software by causing a processor to interpret and execute programs that implement respective functions.

Information on programs, tables, files, and the like for implementing various functions may be stored in a storage device, such as a memory, a hard disk, and a solid state drive (SSD), or in a recording medium, such as an IC card, an SD card, and a DVD.

A group of control lines and data lines considered to be necessary for description are illustrated, and all control lines and information lines needed for configuration are not necessarily illustrated. It is safe to assume that, actually, almost the entire constituent elements are interconnected.

1. An electronic controller comprising:
a virtual machine that accesses a first virtual driver to execute a process;
a hypervisor that calls a first real driver of a first peripheral, based on a peripheral access request received from the first virtual driver;
an access recording unit that calls the first virtual driver to record a peripheral access request transmitted to the hypervisor;
a state recording unit that calls the first real driver to record a state of a register of the first peripheral; and
a monitoring unit that monitors an operation of the hypervisor,
wherein the monitoring unit determines an abnormality of the hypervisor, based on a record by the access recording unit and on a record by the state recording unit.

2. The electronic controller according to claim 1, wherein when a record by the access recording unit and a record by the state recording unit do not match, the monitoring unit determines that the hypervisor is in an abnormal state.

3. The electronic controller according to claim 2, wherein the state recording unit repeatedly acquires a state of the register at a given timing.

4. The electronic controller according to claim 2, wherein the monitoring unit determines that the hypervisor is in an abnormal state when a record of an access request is present in the access recording unit, a record of a process result of the real driver having been sent back to the virtual driver as a reply indicative of normal completion is present, and a state of a register of the state recording unit does not change.

5. The electronic controller according to claim 1, comprising a monitoring result storing unit that when the monitoring unit determines an abnormality, stores a record by the access recording unit and a record by the state recording unit in a nonvolatile memory.

6. The electronic controller according to claim 5, wherein when a frequency of determination of the hypervisor being in an abnormal state is equal to or larger than a given threshold, the monitoring result storing unit brings the electronic controller partially or entirely to a stop.

7. The electronic controller according to claim 1, comprising:
a second peripheral different from the first peripheral; and
a second real driver for operating the second peripheral,
wherein
following an instruction from the second real driver, the second peripheral outputs a record by the access recording unit to outside of the virtual machine, and
the monitoring unit refers to the record by the access recording unit, the record being outputted to the outside of the virtual machine.

8. An abnormality determination method for a hypervisor that operates in an electronic controller,
wherein the electronic controller includes:
a virtual machine that accesses a first virtual driver to execute a process;
the hypervisor that calls a first real driver of a first peripheral, based on a peripheral access request received from the first virtual driver;
an access recording unit that calls the first virtual driver to record a peripheral access request transmitted to the hypervisor;
a state recording unit that calls the first real driver to record a state of a register of the first peripheral; and
a monitoring unit that monitors an operation of the hypervisor, and
the abnormality determination method comprises:
causing the state recording unit to call the first real driver and record a state of a register of the first peripheral; and
causing the monitoring unit to determine an abnormality of the hypervisor, based on a record by the access recording unit and a record by the state recording unit.
